(19) United States
(12) Patent Application Publication
(10) Pub. No.: US 2015/0064083 A1
(43) Pub. Date: Mar. 5, 2015

(54) INJECTOR GRID FOR HIGH AND LOW DUST ENVIRONMENT SELECTIVE CATALYTIC REDUCTION SYSTEMS

(71) Applicant: ALSTOM Technology Ltd, Baden (CH)

(72) Inventors: Mitchell B. COHEN, West Hartford, CT (US); Paul R. THIBEAULT, Windsor, CT (US)

(73) Assignee: ALSTOM Technology Ltd, Baden (CH)

(21) Appl. No.: 14/012,244

(22) Filed: Aug. 28, 2013

(51) Int. Cl. B01D 53/86

(52) U.S. Cl. CPC B01D 53/8631
USPC 423/210; 422/168

(57) ABSTRACT

A method and an arrangement 22 for supplying and mixing a reducing agent into a flue gas FG flowing through a gas duct 14 and into a selective catalytic reduction (SCR) reactor 18 arranged downstream of the arrangement 22. The subject arrangement 22 is useful in both high and low dust environments to mitigate ash and like particulate accumulation on reducing agent nozzles 42 and to provide more uniform reducing agent flow distribution upstream of the SCR reactor 18.

### FIELD OF THE INVENTION

The present invention relates to an arrangement for supplying and mixing a reducing agent into a flue gas flowing through a duct and into a selective catalytic reduction (SCR) reactor arranged downstream of said arrangement. The subject arrangement is useful in both high and low dust environments to mitigate ash and like particulate accumulation on reducing agent nozzles and to provide uniform reducing agent flow distribution upstream of the SCR reactor.

### BACKGROUND OF THE INVENTION

Combustion of a fuel such as coal, oil, natural gas, peat, waste, or the like, in a combustion plant such as a power plant or a waste incineration plant, generates a process gas. Separating nitrogen oxides denoted herein as “NOx”, from such a process gas or “flue gas”, frequently is accomplished using a reducing agent such as ammonia or urea. The ammonia or urea reducing agent is mixed with the flue gas, with the mixture then passed through a catalyst for a selective reaction of the reducing agent with the flue gas NOx to form nitrogen gas and water vapor. Usually the catalyst is installed in what is commonly called a selective catalytic reduction (SCR) reactor. The mixing of the reducing agent and the flue gas is accomplished in a gas duct upstream of the SCR reactor.

Reducing agent is supplied to the gas duct by a plurality of lances and nozzles arranged within the gas duct. To facilitate an even concentration distribution of NOx and reducing agent across a particular cross section of the gas duct, and thus also over a particular cross section of the SCR reactor, mixing devices are arranged in the gas duct downstream of the reducing agent supply to cause turbulent flow and mixing of the flue gas and reducing agent.

However, a problem in many systems is that the concentration of NOx and reducing agent is not evenly distributed in the flue gas across a particular cross section of the SCR reactor. This is a problem because the stoichiometric ratio between the NOx and the reducing agent is essential for achieving efficient reduction of the NOx content within the flue gas and a low slip of reducing agent from the SCR reactor.

DE 3723618 C1 discloses a device for mixing together two gases in a gas duct for a purpose such as that noted above. One of the gases is supplied by a number of nozzles arranged in rows on parallel nozzle lances. Along with the nozzle lances, a flow element in the shape of a baffle is provided arranged in such a way that a further flow channel is formed in each case on a side of the flow baffle facing away from an assigned nozzle.

### SUMMARY OF THE INVENTION

An object of the present disclosure is to provide a robust injector arrangement that provides reducing agent and flue gas intermixing with reduced ash accumulation on reducing agent injection lances and nozzles over that of the described prior art device. As such, reduced ash accumulation on reducing agent injection lances and nozzles promotes improved reducing agent flow and more uniform reducing agent concentration distribution over a particular cross section of a gas duct. Additionally, installation and use of the subject injector arrangement within a gas duct results in a minimum increase in pressure drop upstream of a SCR reactor as is greatly desired.

The above stated object is achieved by the subject reducing agent injector arrangement useful for supplying a reducing agent in gaseous or liquid form into a flue gas flowing through a gas duct fluidly communicating with a catalyst in a selective catalytic reduction (SCR) reactor arranged downstream of the subject injector arrangement. The subject injector arrangement comprises a plurality of nozzles staggered on one or more, or two to eight, injector grid elliptical branch lances arranged in a gas duct perpendicular to the direction of flue gas flow through the gas duct. Each of the one or more, or two to eight, injector grid elliptical branch lances equipped with a plurality of nozzles is controlled by preferably one flow-adjusting control valve, although more valves could be used, for reducing agent and flue gas intermixing. As such, the plurality of nozzles are arranged to supply reducing agent within the gas duct for intermixing and consistent concentration distribution with said flue gas flowing through the gas duct.

The subject injector arrangement provides a relatively efficient and uniform concentration intermixing of the supplied reducing agent throughout the flue gas over a particular or given cross section of the gas duct downstream of the injector arrangement. Furthermore, the subject injector arrangement is robust with respect to variations in power plant operating conditions such as in either high or low dust environments. Supplying reducing agent using the subject injector arrangement mitigates dust, boiler ash, or like particulate accumulation on reducing agent injection lances and nozzles providing the advantage of improved reducing agent flow and uniform concentration distribution prior to entry into a downstream SCR reactor. As such, the subject injector arrangement supplies reducing agent into the passing stream of flue gas in a very evenly distributed manner regardless of environment, and minimizes pressure drops within the gas duct as desired.

The subject injector arrangement is thus useful for supplying and mixing a reducing agent into a flue gas flowing in a gas duct communicating with a catalyst in a selective catalytic reduction reactor downstream of the arrangement. For this purpose, the injector arrangement comprises a reducing agent supply for a supply of reducing agent for flow through fluidly connected elliptical main supply lance, elliptical branch lances, staggered injection pipes and nozzles for injection of the reducing agent from the nozzles into the flue gas flowing through the gas duct.

According to one embodiment, the elliptical main supply lance is fluidly connected to one or more elliptical branch lances.

According to another embodiment, the elliptical main supply lance is fluidly connected to two to eight elliptical branch lances.

According to another embodiment, the elliptical branch lances are fluidly connected to approximately 5 to approximately 20 staggered injection pipes.

According to another embodiment, the staggered injection pipes are equipped with removably fixed cap members each with an opening forming a nozzle.

According to another embodiment, the nozzles may be cleaned by removing removably fixed cap members from staggered injection pipes and replacement with new or cleaned cap members.

According to another embodiment, the elliptical shape of the elliptical main supply lance and the elliptical branch lances reduce pressure drop in the gas duct over that of round piping.

According to another embodiment, the elliptical shape of the elliptical main supply lance and the elliptical branch lances reduce particulate accumulation on nozzles improving reducing agent flow and more uniform reducing agent concentration distribution within the gas duct over that of round piping.

A method of using the subject injector arrangement to supply and mix a reducing agent into a flue gas flowing in a gas duct communicating with a catalyst in a selective catalytic reduction reactor downstream of said arrangement, comprises providing a supply of reducing agent for flow through fluidly connected elliptical main supply lance, elliptical branch lances, staggered injection pipes and nozzles for injection of the supply of reducing agent from the nozzles into the flue gas flowing through the gas duct.

According to one method, the elliptical main supply lance is fluidly connected to one or more elliptical branch lances.

According to another method, the elliptical branch lances are fluidly connected to approximately 5 to approximately 20 staggered injection pipes.

According to another method, the staggered injection pipes are equipped with removably fixed cap members each with an opening forming a nozzle.

According to another method, the nozzles may be cleaned by removing removably fixed cap members from staggered injection pipes and replacement with new or cleaned cap members.

According to another method, the elliptical shape of the elliptical main supply lance and the elliptical branch lances reduce pressure drop in the gas duct over that of round piping.

According to another method, the elliptical shape of the elliptical main supply lance and the elliptical branch lances reduce particulate accumulation on nozzles improving reducing agent flow and more uniform reducing agent concentration distribution within the gas duct over that of round piping.

Further objects and features of the subject injector arrangement and method of using the subject injector arrangement will be apparent from the following detailed description and claims.

### BRIEF DESCRIPTION OF THE DRAWINGS

The subject injector arrangement will now be described in more detail with reference to the appended drawings described below.

FIG. 1 is a schematic side view of a plant with a reducing agent injection grid according to the present invention.

FIG. 2 is an enlarged schematic side perspective view of the reducing agent injection grid of FIG. 1.

FIG. 3 is a schematic end cross sectional view taken at line 3-3 of the reducing agent injection grid of FIG. 2.

### DESCRIPTION OF PREFERRED EMBODIMENTS

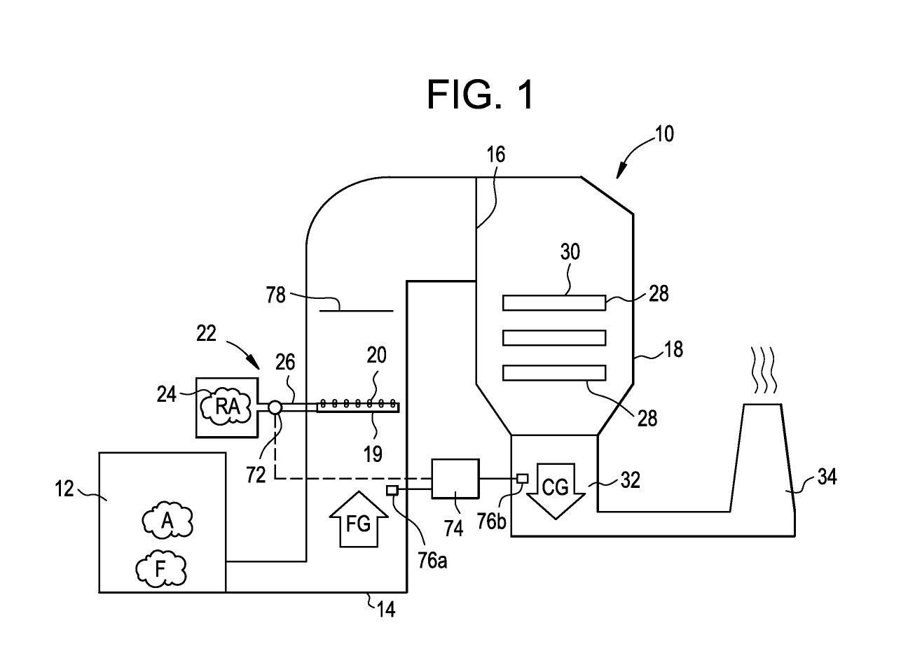

Power plants are typically powered using coal, oil, natural gas, peat, waste, or like fuel fired boilers. According to the present power plant system 10 illustrated in FIG. 1, fuel is combusted in a boiler 12 in the presence of air A, thereby generating a flow of process gas in the form of a flue gas, FG, that flows out from the boiler 12 via a fluidly connected gas duct 14. Through gas duct 14, flue gas FG flows to an inlet 16 of a selective catalytic reduction (SCR) reactor 18. FIG. 1 illustrates an injector arrangement 19 in the form of a reducing agent injection grid 20 arranged across gas duct 14 perpendicular to the flow of flue gas FG through gas duct 14, and upstream with regard to flue gas FG flow to SCR reactor 18. A reducing agent supply system 22 is operative for supplying a reducing agent such as ammonia or urea, but preferably ammonia in a gas form, more preferably in a diluted gas form, and most preferably in a diluted gas form diluted with air, from a reducing agent supply 24 through a fluidly connected reducing agent pipe 26 to the reducing agent injection grid 20. One or more flow-adjusting control valves 72 are used to control flow of reducing agent through one or more reducing agent pipes 26 to the reducing agent injection grid 20. As such, the reducing agent injection grid 20 supplies diluted or undiluted gaseous ammonia, NH₃, to the flue gas FG flowing through gas duct 14 prior to its flow into SCR reactor 18. The SCR reactor 18 comprises one or more consecutive layers 28 of SCR catalyst 30 arranged inside the SCR reactor 18. The SCR catalyst 30 can by way of example comprise a catalytically active component, such as a vanadium pentoxide (V₂O₅) and titanium dioxide (TiO₂) substrate with other chemical additives such as wolfram trioxide (WO₃) and molybdenum trioxide (MoO₃), applied to a ceramic honeycomb carrier material or parallel plate structures (not shown). In the SCR reactor 18 the nitrogen oxides, NOx, in the flue gas FG react with the ammonia supplied through the reducing agent injection grid 20 to form nitrogen gas, N₂, and water vapor. Following this reaction in the SCR reactor 18, “cleaned” flue gas CG flows out from the SCR reactor 18 via a fluidly connected exit duct 32 for emission into the atmosphere via a fluidly connected stack 34. It will be appreciated that the power plant system 10 may comprise further gas cleaning devices, such as dry and/or wet scrubbers, and particulate removers, such as electrostatic precipitators and fabric filters, not illustrated in the figures provided herewith for purposes of clarity.

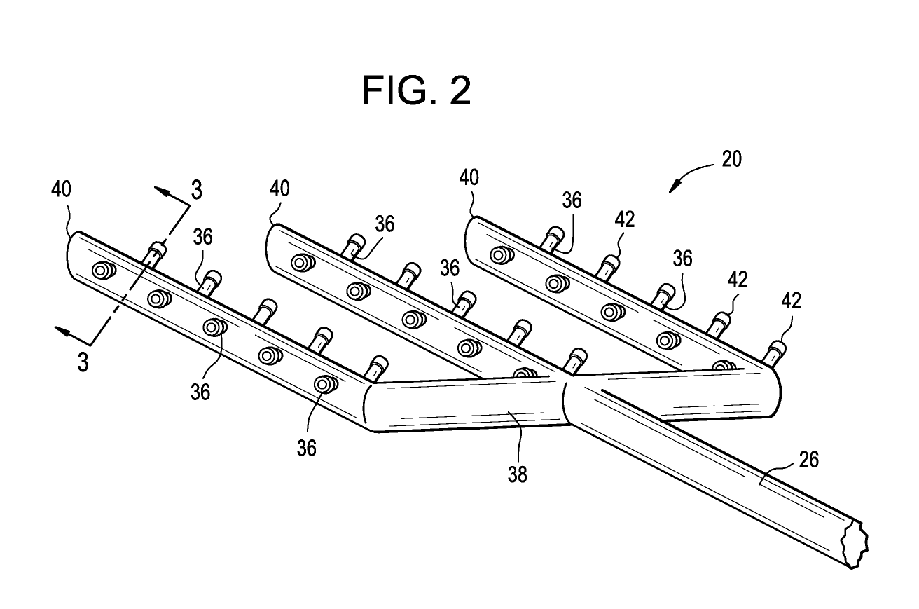

As best illustrated in FIG. 2, the reducing agent injection grid 20 comprises a plurality of staggered injection pipes 36 each with a nozzle 42 fluidly connected to an elliptical main supply lance 38 via fluidly connected elliptical branch lances 40 therebetween. From reducing agent supply 24 through fluidly connected reducing agent pipe 26, elliptical main supply lance 38, elliptical branch lances 40 and staggered injection pipes 36, reducing agent flows for release within gas duct 14 for intermixing with flue gas FG flowing therethrough.

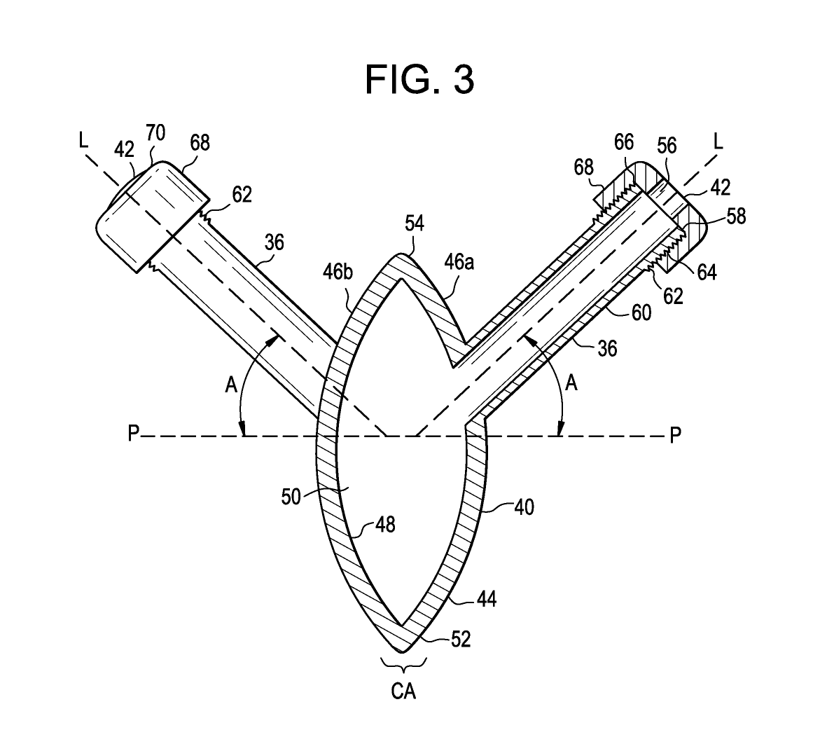

As best illustrated in FIG. 3, elliptical branch lances 40 are elliptical in form. As such, each elliptical branch lance 40 is formed by opposed side walls 46a and 46b. Opposed side walls 46a and 46b form opposed exterior surface 44 and interior surface 48 of elliptical branch lance 40. Opposed side walls 46a and 46b join at upstream apex 52 and downstream apex 54. Flue gas FG flowing through gas duct 14 first contacts upstream apex 52 before flowing past downstream apex 54. This elliptical form of both the elliptical main supply lance 38 and the elliptical branch lances 40, mitigates ash and like particulate accumulation on nozzles 42 by reducing flue gas FG recirculation, or eddies, that typically occur as flue gas flows around round injection piping. Round injection piping of the prior art creates flue gas recirculation or eddies due to a relatively large flue gas initial contact area. This relatively large flue gas initial contact area blocks and redirects flue gas flow thereby causing an increased pressure drop and increased flue gas recirculation or eddie formation. As illustrated in FIG. 3, the elliptical form of both the elliptical main supply lance 38 and the elliptical branch lances 40 feature a relatively small flue gas FG initial contact area CA. This relatively small flue gas FG initial contact area CA provides minimal blockage and redirection of flue gas FG flow, thereby minimizing pressure drop and flue gas FG recirculation or eddie formation. Minimizing flue gas FG recirculation is highly desirable to prevent nozzle 42 plugging and resultant poor reducing agent injection and concentration distribution with flue gas FG flowing within gas duct 14.

The elliptical main supply lance 38 is preferably equipped with one or more, or two to eight elliptical branch lances 40. Interior surface 48 defines interior area 50 of elliptical branch lance 40 through which reducing agent flows to fluidly connected staggered injection pipes 36. Each elliptical branch lance 40 ranges in length from approximately 1 meter (m) to approximately 4 m in length and may be equipped with a total of approximately 5 to approximately 20 staggered injection pipes 36. As illustrated, staggered injection pipes 36 protrude approximately 8 centimeters (cm) to approximately 20 cm from exterior surface 44 of opposed side walls 46a and 46b of elliptical branch lances 40. Staggered injection pipes 36 are staggered in that staggered injection pipes 36 protruding from side wall 46a are arranged so as to be between staggered injection pipes 36 protruding from side wall 46b, and vice versa. This staggered arrangement of staggered injection pipes 36 allows for more uniform distribution and flow of reducing agent within gas duct 14.

It is to be understood that the number of staggered injection pipes 36 and their positioning relatively near downstream apex 54 of elliptical branch lances 40 may be varied. The number of staggered injection pipes 36 should be adapted to parameters such as the quality of the flue gas, the dimensions of the elliptical branch lance 40 and gas duct 14, and the quantity of reducing agent and dilution air required for the SCR reactor 18.

Staggered injection pipes 36 as best illustrated in FIG. 3 protrude from exterior surface 44 of opposed side walls 46a and 46b of elliptical branch lances 40. The staggered injection pipes 36 protrude from exterior surface 44 relatively near downstream apex 54, as compared to upstream apex 52, and at an angle A of approximately 45 degrees to approximately 50 degrees toward downstream apex 54 measuring from longitudinal axis L of staggered injection pipes 36 to plane P-P perpendicular to the flow of flue gas FG through gas duct 14. Opposite from staggered injection pipe 36 connection with exterior surface 44 is staggered injection pipe 36 free end 58. On exterior surface 60 of staggered injection pipe 36 at free end 58 is threading 62. Threading 62 on staggered injection pipe 36 is compatible for male-female interlocking with threading 64 on interior surface 66 of cap member 68 arranged over free end 58 of staggered injection pipe 36. Although threading 62, 64 is described herein for removably fixing cap member 68 to staggered injection pipe 36, other means of removably fixing cap member 68 to staggered injection pipe 36 known to those skilled in the art would likewise be acceptable. Opening 56 through free end 70 of cap member 68 forms nozzle 42. Threading 62, 64 provides for ready adjustment of nozzles 42 through use of differing cap members 68 with openings 56 of varying size. Likewise cleaning of nozzles 42 may be achieved with relative ease through removal of dirty nozzles 42 and replacement thereof with new or cleaned nozzles 42. Each nozzle 42 is preferably operated to provide a continuous flow of reducing agent from the reducing agent supply 24, through fluidly connected reducing agent pipe 26, through fluidly connected elliptical main supply lance 38, through fluidly connected elliptical branch lances 40, and through staggered injection pipes 36 into gas duct 14.

The reducing agent supply system 22 provides a ready supply of reducing agent to gas duct 14. Reducing agent supply 24 can be in the form of a tank used in combination with a vaporization skid and flow control skid, or another suitable storage arrangement known to those skilled in the art. As nonlimiting examples, the reducing agent can be ammonia or urea. In case of ammonia, it can either be delivered to the power plant 10 in gaseous form, or be delivered in liquid form for later vaporization and dilution before injection into gas duct 14. Maintaining ammonia and dilution air in superheated gaseous form, avoids problems associated with deposit formation due to droplets or condensation interacting with flue gas FG particulates.

The reducing agent supply system 22 is disclosed thus far with a single unitary reducing agent injection grid 20 comprising a plurality of staggered injection pipes 36 each with a nozzle 42 fluidly connected to an elliptical main supply lance 38 via fluidly connected elliptical branch lances 40 therebetween. However, it is to be understood that the reducing agent supply system 22 could be expanded to include one or more different reducing agent injection grids 20 positioned in gas duct 14 to be provided with different amounts of reducing agent or with different degrees of pressurization. The latter can be useful if it has been detected by measurements made downstream of the SCR reactor 18 that there is a non-uniform NOx distribution profile.

Additionally, reducing agent supply system 22 may be connected to a control system 74 to regulate a supply of reducing agent to gas duct 14 based on an amount of NOx measured by one or more sensors 76b in the flue gas FG downstream of the SCR reactor 18. Such control system 74 may directly or by electronic signal flow-adjusting control valve 72 to control or regulate reducing agent flow through nozzles 42.

As further illustrated in FIG. 1, a first NOx sensor 76a is operative for measuring the amount of NOx in the flue gas of gas duct 14 after the boiler 12 and upstream of the SCR reactor 18. A second NOx sensor 76b is operative for measuring the amount of NOx in the flue gas of exit duct 32 downstream of the SCR reactor 18. The control system 74 receives data input from the first NOx analyzer 76a and the second NOx sensor 76b. Based on that data input, the control system 74 calculates a present NOx removal efficiency. The calculated present NOx removal efficiency is compared to a NOx removal set point. Based on the result of the comparison, the amount of reducing agent supplied to the flue gas FG is adjusted for optimal efficiency.

It is to be understood that when a control system 74 is used, the particular embodiment described herein is only one possible solution. Control system 74 may be varied to control NO_{X} reduction efficiency of the SCR reactor 18, depending upon the required outlet NO_{X} emission level to be achieved.

It is also to be understood that a load sensor (not shown) operative for sensing the load on the boiler 12 may be used. Such load could be expressed in terms of, for example, the amount of fuel, such as ton/hour of coal transported to the boiler 12. The data signal from such load sensor is useful to further control the amount of reducing agent supplied to gas duct 14 via nozzles 42. According to one embodiment, flue gas NOx profile data is generated on a regular basis, based on NOx measurements performed upstream and/or downstream of the SCR reactor 18. An advantage of this embodiment is that changes in the NOx profile, such changes being caused by, for example, a change in the load on the boiler, a change in the fuel quality, a change in the status of the burners of the boiler, and the like, can be accounted for through control of the amount of reducing agent supplied to gas duct 14, such that efficient NOx removal can be ensured at all times.

It is also to be understood that the NOx profile data could be obtained by making manual measurements, to determine a suitable amount of reducing agent is supplied by nozzles 42 to the flue gas FG in gas duct 14.

It has been described hereinbefore, that the present invention can be utilized for reducing NO_{X} emissions from a process flue gas FG generated in a coal fired boiler 12. It will be appreciated that the invention is useful also for other types of reagent injection processes, e.g., liquid sorbent injection systems, and other types of process gases, including process gases generated in gas and oil fired boilers, incineration plants, including waste incineration plants, cement kilns, blast furnaces, combined cycle plants and other metallurgical plants including sinter belts, and the like.

Likewise, it is to be understood that the gas duct 14 can be provided with one or more mixing plates 78 of any geometry, downstream or upstream of the reducing agent injection grid 20 to increase the turbulence and intermixing of reducing agent with the flue gas FG.

To summarize, the present disclosure provides an injector arrangement 19 for supplying and mixing a reducing agent RA into a flue gas FG flowing in a gas duct 14 communicating with a catalyst 30 in a selective catalytic reduction reactor 18 downstream of the injector arrangement 19. The injector arrangement 19 comprises a reducing agent supply 24 for a supply of reducing agent RA for flow through fluidly connected elliptical main supply lance 38, elliptical branch lances 40, staggered injection pipes 36 and nozzles 42 for injection of the reducing agent RA from the nozzles 42 into the flue gas FG flowing through the gas duct 14.

According to one embodiment, the elliptical main supply lance 38 is fluidly connected to one or more elliptical branch lances 40.

According to another embodiment, the elliptical main supply lance 38 is fluidly connected to two to eight elliptical branch lances 40.

According to another embodiment, the elliptical branch lances 40 are fluidly connected to approximately 5 to approximately 20 staggered injection pipes 36.

According to another embodiment, the staggered injection pipes 36 are equipped with removably fixed cap members 68 each with an opening 56 forming a nozzle 42.

According to another embodiment, the nozzles 42 may be cleaned by removing removably fixed cap members 68 from staggered injection pipes 36 and replacement with new or cleaned cap members 68.

According to another embodiment, the elliptical shape of the elliptical main supply lance 38 and the elliptical branch lances 40 reduce pressure drop in the gas duct 14 over that of round piping.

According to another embodiment, the elliptical shape of the elliptical main supply lance 38 and the elliptical branch lances 40 reduce particulate accumulation on nozzles 42 improving reducing agent RA flow and providing more uniform reducing agent RA concentration distribution within the gas duct 14 over that of round piping.

A method of using the subject injector arrangement 19 to supply and mix a reducing agent RA into a flue gas FG flowing in a gas duct 14 communicating with a catalyst 30 in a selective catalytic reduction reactor 18 downstream of said arrangement 19, comprises providing a supply of reducing agent RA for flow through fluidly connected elliptical main supply lance 38, elliptical branch lances 40, staggered injection pipes 36 and nozzles 42 for injection of the supply of reducing agent RA from the nozzles 42 into the flue gas FG flowing through the gas duct 14.

According to one method, the elliptical main supply lance 38 is fluidly connected to one or more elliptical branch lances 40.

According to another method, the elliptical branch lances 38 are fluidly connected to approximately 5 to approximately 20 staggered injection pipes 36.

According to another method, the staggered injection pipes 36 are equipped with removably fixed cap members 68 each with an opening 56 forming a nozzle 42.

According to another method, the nozzles 42 may be cleaned by removing removably fixed cap members 68 from staggered injection pipes 36 and replacement with new or cleaned cap members 68.

According to another method, the elliptical shape of the elliptical main supply lance 38 and the elliptical branch lances 40 reduce pressure drop in the gas duct 14 over that of round piping.

According to another method, the elliptical shape of the elliptical main supply lance 38 and the elliptical branch lances 40 reduce particulate accumulation on nozzles 42 improving reducing agent RA flow and more uniform reducing agent RA concentration distribution within the gas duct 14 over that of round piping.

It will be appreciated that numerous variants of the above described embodiments of the present invention are possible within the scope of the appended claims.

1. An arrangement for supplying and mixing a reducing agent into a flue gas flowing in a gas duct communicating with a catalyst in a selective catalytic reduction reactor downstream of the arrangement, the arrangement comprising:
a reducing agent supply for a supply of reducing agent for flow through fluidly connected elliptical main supply lance, elliptical branch lances, staggered injection pipes and nozzles for injection of the reducing agent from the nozzles into the flue gas flowing through the gas duct.

2. The arrangement of claim 1, wherein the elliptical main supply lance is fluidly connected to one or more elliptical branch lances.

3. The arrangement of claim 1, wherein the elliptical branch lances are fluidly connected to approximately 5 to approximately 20 staggered injection pipes.

4. The arrangement of claim 1, wherein the staggered injection pipes are equipped with removably fixed cap members.

5. The arrangement of claim 1, wherein the staggered injection pipes are equipped with removably fixed cap members each with an opening forming a nozzle.

6. The arrangement of claim 1, wherein the nozzles may be cleaned by removing removably fixed cap members from staggered injection pipes and replacement with new or cleaned cap members.

7. The arrangement of claim 1, wherein the elliptical shape of the elliptical main supply lance and the elliptical branch lances reduce pressure drop in the gas duct over that of round piping.

8. The arrangement of claim 1, wherein the elliptical shape of the elliptical main supply lance and the elliptical branch lances reduce particulate accumulation on nozzles improving reducing agent flow and providing more uniform reducing agent concentration distribution within the gas duct over that of round piping.

9. A method of using an arrangement to supply and mix a reducing agent into a flue gas flowing in a gas duct communicating with a catalyst in a selective catalytic reduction reactor downstream of said arrangement, the method comprising:
providing a supply of reducing agent for flow through fluidly connected elliptical main supply lance, elliptical branch lances, staggered injection pipes and nozzles for injection of the supply of reducing agent from the nozzles into the flue gas flowing through the gas duct.

10. The method of claim 9, wherein the elliptical main supply lance is fluidly connected to one or more elliptical branch lances.

11. The method of claim 9, wherein the elliptical branch lances are fluidly connected to approximately 5 to approximately 20 staggered injection pipes.

12. The method of claim 9, wherein the staggered injection pipes are equipped with removably fixed cap members each with an opening forming a nozzle.

13. The method of claim 9, wherein the nozzles may be cleaned by removing removably fixed cap members from staggered injection pipes and replacement with new or cleaned cap members.

14. The method of claim 9, wherein the elliptical shape of the elliptical main supply lance and the elliptical branch lances reduce pressure drop in the gas duct over that of round piping.

15. The method of claim 9, wherein the elliptical shape of the elliptical main supply lance and the elliptical branch lances reduce particulate accumulation on nozzles improving reducing agent flow and providing more uniform reducing agent concentration distribution within the gas duct over that of round piping.
